(19) United States
(12) Patent Application Publication
(10) Pub. No.: US 2007/0065792 A1
(43) Pub. Date: Mar. 22, 2007

(54) Dental hygiene tutorial toy

(76) Inventor: Wanda Schubarth, Bowling Green, KY (US)

Correspondence Address: Michael Coblenz, 752 Rose Hurst Way, Lexington, KY, 40515, US

(21) Appl. No.: 11/521,154

(22) Filed: Sep. 14, 2006

Related U.S. Application Data
(60) Provisional application No. 60/718,554, filed on Sep. 19, 2005.

(51) Int. Cl. G09B 23/28

(52) U.S. Cl. 434/263

(57) ABSTRACT

A dental hygiene tutorial toy which is configured to look like a child's doll and which contains a sound generating device that offers a child user information regarding proper dental hygiene and encouragement regarding brushing. The dental hygiene tutorial toy also includes an integrated timer to ensure that the child brushes his or her teeth thoroughly. Embodiments of the dental hygiene tutorial toy may include holders for a toothbrush, a tube of toothpaste, or a drinking cup. Also disclosed is a method for instructing children in proper dental hygiene comprising the steps of providing a child friendly dental hygiene tutorial toy with an integrated sound generating device that provides instruction and encouragement to ensure the proper brushing of teeth.

### CROSS REFERENCE TO RELATED APPLICATIONS

This application claims priority to U.S. provisional application Ser. No. 60/718,554, filed Sep. 19, 2005, and incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to a method and device for instructing and encouraging young children to properly brush their teeth by providing a dental hygiene tutorial toy configured to look like a child's toy, and which provides an audible message regarding proper dental hygiene.

2. Description of the Related Art

As any parent or guardian knows, getting small children to properly brush their teeth can be a chore. For any number of reasons, children do not like to brush their teeth, and it is often time consuming and frustrating for the adult to try to cajole the child to brush, and even when they do brush it is often difficult to get them to brush properly and for a sufficient length of time.

There are many different methods that have been tried in the past to encourage young children to brush properly. There are many decorative toothbrushes that are configured to look like dolls or have famous cartoon characters on them. These increase the likelihood that a child will pick up a toothbrush, and therefore increase the potential that they will put it in their mouths and brush their teeth. There are also child friendly flavored toothpastes, in such flavors as grape, cherry, and bubble gum, to name a few. This undoubtedly increase the likelihood that children will put toothpaste on a brush and put it into their mouths, which is certainly an important first step, but it does not ensure that the child will brush properly. Both the child friendly toothbrush and toothpaste increase the likelihood that a child will brush, but do nothing to ensure that they brush properly, or engage in other important dental hygiene practices, such as flossing. There is a need, therefore, for a child friendly device that will instruct and encourage children to learn about and hopefully engage in proper dental hygiene.

Talking and interactive dolls are well known in the art. They come in a variety of shapes and configurations, provide a variety of different messages, and are for a variety of different purposes. Some are purely for entertainment, such as U.S. Pat. No. 4,802,879, to Rissman et al, which provides an action figure with a visual display that represents a beating heart with flowing blood, and also includes a sound generator that provides a variety of unspecified sounds associated with action figure. As can be appreciated, the '879 patent is designed purely for entertainment purposes.

There are also a number of instructional talking and interactive dolls. One example is U.S. Pat. No. 5,607,336 to Lebensfeld et al, which discloses a doll with a number of changeable message producing microchips and corresponding outfits. The user of the doll inserts a micro-chip and dresses the doll in a corresponding outfit, and the microchip produces words and phrases relating to the outfit that the doll is wearing. Examples provided in the patent disclosure include an evening gown and swimwear, but the disclosure also mentions that a child could select any number of related micro-chips and outfits for a variety of sports and leisure activities, or for a variety of professions, such as doctors and lawyers. The words produced by the micro-chip appear to be the type of words uttered by a person wearing the corresponding outfit, and do not appear to be instructional, for example regarding the associated profession.

U.S. Pat. No. 5,820,440 to Truchsess, discloses a talking doll with a specialized activation device. The activation device is located in the dolls rump area, and is designed to encourage children to handle the doll properly in an attempt to encourage children to play properly with living children. The audible sounds that the doll produces includes laughs, songs, or nursery rhymes, and only play when the doll is bounced on the child's knee. U.S. Pat. No. 6,882,824 to Wood, discloses a doll with a key pad on the chest area. The child user can press various keys on the chest and the doll will respond. For example, in once configuration the key pad consists of the letters of the alphabet, and the doll will say the letter when the corresponding key is pressed. Finally, U.S. Pat. No. 6,106,358 discloses a doll that recites a randomly selected biblical passage when activated.

Each of these prior art interactive talking dolls serves a particular purpose, but none discloses a talking doll or figurine that provides age appropriate dental hygiene instruction or encouragement.

### SUMMARY OF THE INVENTION

The invention relates to a toy figure with an internal sound generator that dispenses dental hygiene information. Instructing children in proper dental hygiene and ensuring that they brush properly and for a sufficient length of time has always been a problem for parents and guardians. It is, therefore, an object of the present invention to address that problem by providing a dental hygiene tutorial toy that is configured in a child friendly and child appealing way. Specifically, the dental hygiene tutorial toy is configured to appear like a typical child's toy. In various configurations the invention can resemble a variety of toys, such as stuffed bears or other animals, Barbie® like female figures, or baby-doll toys. Some configurations will appeal to younger children, while others will appeal to slightly older children. In other configurations, therefore, the invention can be configured to resemble a variety of cartoon or comic book characters, television or movie characters, both real and animated, or a variety of super-hero type characters such as Superman®, Batman®, or Spiderman®, to name just a few.

The invention is electronic and will have an ON/OFF switch that in some configurations will be integrated with the character. So, for example, if the invention is configured as a bunny, the child might pull an ear or squeeze a paw to turn on the invention. If the invention is configured as a superhero, the child might shake the characters hand to turn on the invention.

It is an object of the invention to provide a dental hygiene tutorial toy that provides dental hygiene instruction and information. To that end, the invention contains an internal sound generating device which contains a series of prerecorded dental hygiene messages that instruct children in a variety of proper dental hygiene practices such as proper brushing, the need for flossing, the proper use of mouth washes, and other age appropriate dental care information.

It is a further object of the invention to provide a device that instructs children on the proper length of time to thoroughly brush their teeth. Pediatric dentists recommend that children brush for at least two minutes. The present invention, therefore, includes an integrated timing device to notify the child that they have brushed for the appropriate length of time.

As most parents and guardians know, it is often difficult to convince children to brush for the required two minutes. Therefore it is a further object of the invention to provide encouragement to brush for the appropriate time. To accomplish this there is provided, in addition to the incorporated timer and prerecorded dental hygiene instruction, a variety of encouraging messages and other sounds, including music and songs. Encouraging messages can include such words and phrases as “way to go” and “keep on brushing” as well as many other things. Other forms of encouragement can include music or songs, both to encourage and distract the child so that they will not become bored during brushing. It is well known that children are often stimulated by music, and it is an object of the invention to provide a variety of music to stimulate and encourage the child to stay on the task of brushing their teeth. Other forms of encouraging sounds include, but are not limited to, cheering and crowd noises.

It is within the conception of the present invention that the sound generating device might also include a recording feature so that a parent, guardian, or other familiar adult might record the dental hygiene instruction or encouraging patter.

In various embodiments of the invention, the dental hygiene tutorial toy might also include an integrated toothbrush, toothpaste, or drinking cup holder. In one embodiment, these holders might be incorporated in a base upon which the character portion of the dental hygiene tutorial toy sits. In another embodiment of the invention these holders would be incorporated with the character, so for example, a toothbrush holder might be in the hand of the character, giving the appearance that the character is offering the child the toothbrush, thus further encouraging the child to brush.

In alternate embodiments of the invention the power switch would be incorporated with the toothbrush or toothpaste holder so that the device would be activated when the child takes the toothbrush or toothpaste from the holder. This could also be achieved in alternate embodiments by a light or motion sensitive switch to activate the device. When activated, the device would begin with instruction, such as “make sure to use toothpaste” and “only a pea sized drop is needed” and encouragement, such as “lets get ready to brush.” Then the timer would start, and the device would produce instruction and encouragement during the duration of brushing.

The sound generating device will also contain a randomizer to randomly generate the messages and encouraging sounds and music. This will ensure that the child receive a variety of instruction as well as ensure that the use of the device does not become rote and the child become bored.

The dental hygiene tutorial toy disclosed herein is intended for use on a bathroom countertop or other surface near where children brush their teeth. It is an object of the invention, therefore, that the device be durable, water proof or essentially water proof, easily portable, and designed with no small or easily removable parts that might create a choking hazard.

These and other aspects, features and advantages of the present invention will become apparent from the following detailed description taken in conjunction with the accompanying drawings.

### BRIEF DESCRIPTION OF THE SEVERAL VIEWS OF THE DRAWINGS

For a fuller understanding of the nature and objects of the invention, reference should be had to the following detailed description, taken in connection with the following drawings.

FIG. 1 is a front perspective view of a representative embodiment of the disclosed invention.

FIG. 2 is back elevation view showing a schematic representation of the sound generator and related elements.

FIG. 3 is a back elevation view showing the access panel.

FIG. 4 is a perspective view of a representative embodiment of the invention including a base, and toothbrush and drinking cup holder.

### DETAILED DESCRIPTION OF THE INVENTION

Detailed embodiments of the present invention are disclosed herein. It is to be understood, however, that the disclosed embodiments are merely exemplary of the invention and that the invention may be embodied in various and alternative forms. Therefore, specified structural and functional details disclosed herein are not to be interpreted as limitations, but merely as a basis for the claims and as a representative basis for teaching one skilled in the art to variously employ the present invention.

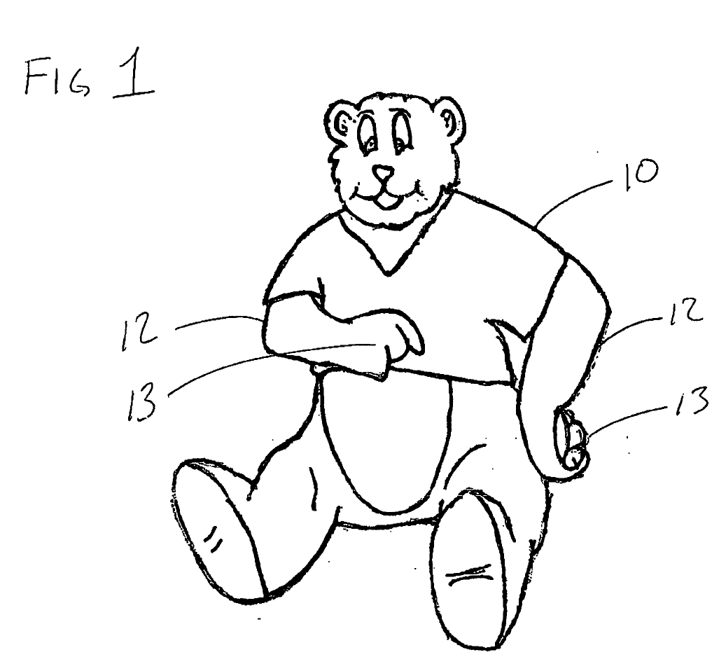

FIG. 1 shows a representative embodiment of the disclosed dental hygiene tutorial toy. The invention is comprised of a body 10. In this representative embodiment, the body 10 is depicted as a bear. The body 10 of the invention can be any configuration that is visually appealing to children, such as any variety of animals, teddy bears, cartoon characters, and television and movie characters, whether real or animated. In the representative embodiment depicted in FIG. 1, the body 10 also has all of the elements typical of the body of a doll, including two arm 12, and two hands 13.

The body 10 of the invention can be made from a variety of different materials. The invention is intended for use by children on a bathroom countertop and therefore needs to be durable and constructed from fully or relatively waterproof materials. In the preferred embodiment, the body 10 is made from hard plastic. In alternate embodiments, the body 10 could be made of soft or hard rubber or soft plastics.

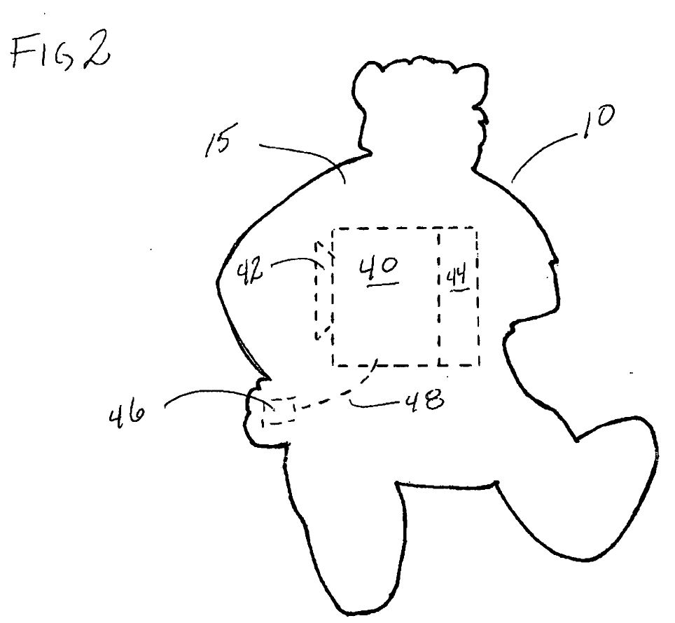

FIG. 2 shows the back 15 of the body 10, along with a schematic representation of the sound generator 40, speaker 42, battery housing 44, activation mechanism 46, and connecting wire 48. The sound generator 40, speaker 42, and battery housing 44 are housed in the interior cavity 30 of the body 10. The sound generator 40 is of the type well known in the art, and can include digital or analog tape recorders, computer chip, or other suitable sound producing devices. Sound is produced by means of the speaker 42, and electrical power is provided to the sound generator 40 by means of batteries (not shown) contained in the battery housing 44. The power is turned on and off by means of the activation mechanism 46. In various embodiments, the activation mechanism 46 can be as simple as an ON/OFF switch on the back of the body 10. In the embodiment depicted in FIG. 1, the activation mechanism is a pressure sensitive ON/OFF switch located in the hand 13 of the body 10, and electronically connected to the battery housing 44 by means of a connecting wire 48. In this embodiment, the sound generator 46 is turned on by squeezing the hand 13 of the invention.

In alternate embodiments, the activation mechanism 46 can be integrated into the configuration of the body 10. For example, in one potential embodiment, the body 10 will be a robot with his hand 13 extended, and the device will be turned on by shaking the hand 13. Other embodiments may include a puppy or a kitty, with the activation mechanism 46 located in the belly, so that power to the device is turned on by rubbing, tickling or patting the belly. In yet another embodiment, the activation mechanism 46 can be a light sensor of the type well known in the art. In this embodiment, the activation mechanism 46 can be mounted in the head or eye (not shown) of the device, and activated by moving the hand near the activation mechanism 46.

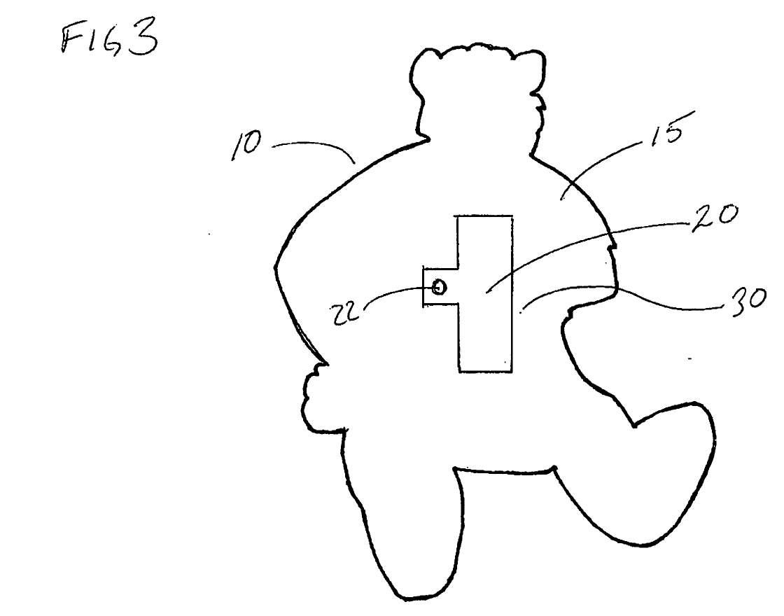

FIG. 3 shows the access panel 20 in the back 15 of the body 10. The access panel 20 provides access into the interior cavity 30 of the body, and access to the battery housing 44. In FIG. 3, the access panel 20 is shown secured by a screw 22. In alternate embodiments, the access panel 20 can be secured by any suitable means.

The sound generator 40 will contain a number or prerecorded messages that will be played when the device is activated by means of the activation mechanism 46. In use, a child will turn on the invention with the activation mechanism 46. The sound generator 40 will provide a dental hygiene message by means of the speaker 42.

The sound generator 40 will provide a variety of dental hygiene messages regarding brushing, flossing, and use of mouthwash, among other topics. Information on brushing will include, but is not limited to such advice as “be sure to get the back teeth” or “brush up and down on the side teeth.” There will also be prerecorded messages of encouragement, such as “keep brushing” or “just one more minute.” There will also be encouraging music, such as nursery rhymes. The sound generator 40 will also contain a randomizer to randomly play different messages and music so that the child will not tire of the same messages and songs every night.

Pediatric dentists recommend that children brush their teeth for at least two minutes. To help children achieve this goal, the sound generator 40 will also contain an integrated timer (not depicted). The timer will be electronically integrated into the sound generator 40 in a manner well known in the art, and will be coordinated with the dental hygiene message that is being played. So, for example, at the very beginning, the message will say “remember to brush for two minutes” or words to that effect, and then later it will give time references, such as “you've brushed for one minute, way to go!” or “only thirty more seconds, keep brushing.” In this way the message from the invention will encourage the child to brush for the recommended two minutes.

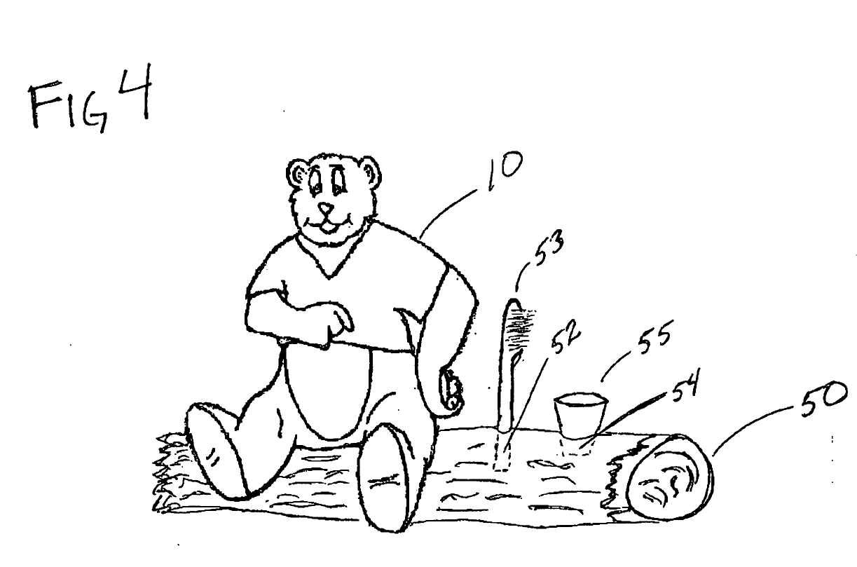

FIG. 4 depicts an embodiment of the dental hygiene tutorial toy with an integrated toothbrush and drinking cup holder. In this embodiment the body 10 is mounted on the base 50. In the representative configuration depicted in FIG. 4, the body 10 is of a bear, and the base 50 is a log, which is frequently associated with bears, because bears are known to scratch themselves against them, and search them for honey. In other configurations of the body 10 and the base 50 will similarly correspond, so for example if the body 10 is a baby doll, the base 50 would be a crib. In another example, if the body 10 is configured as a superhero such as Batman®, the base 50 could be the Batmobile®.

In the embodiment depicted in FIG. 4, the base serves as a toothbrush and drinking cup holder. It is also within the conception of the invention that the base could also serve as a toothpaste holder. The base 50 contains a slot 52 integrated therein. The slot 52 is sized to receive a toothbrush 53. The base 50 also contains a recess 54 integrated therein. The recess 54 is sized to receive a drinking cup 55. It is within the conception of the invention to incorporate the toothbrush, drinking cup, and toothpaste directly into the body 10. In this alternate embodiment of the invention the body 10 would include one hand 13 holding a toothbrush 53, and the other hand 13 holding the drinking cup 55.

The incorporation of the toothbrush 53 and drinking cup 55 into either the body 10 or the base 50 serves two purposes. First it provides ready storage for these dental hygiene products. But more importantly it enhances the visual appeal to children, and will allow children to approach brushing as playtime, and not as a chore.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only be the spirit and scope of the claims, giving full cognizance to equivalents in all respects.

I claim:

1. A dental hygiene tutorial toy comprising:
a body constructed in a child friendly configuration, said body containing an interior cavity therein;
a sound generation device disposed within said interior cavity of said body;
wherein said sound generation device provides prerecorded instruction on proper dental hygiene.

2. The dental hygiene tutorial toy of claim 1 further comprising a timer integrated into said sound generation device; wherein said timer providing notification of proper duration for brushing teeth.

3. The dental hygiene tutorial toy of claim 1, wherein said sound generation device further comprising a speaker, a power source, and an activation mechanism.

4. The dental hygiene tutorial toy of claim 4, wherein said activation mechanism is integrated within said body constructed in a child friendly configuration.

5. The dental hygiene tutorial toy of claim 1 further comprising an electronic randomizer electronically integrated within said sound generation device, wherein said electronic randomizer provides the prerecorded instructions in a random order.

6. The dental hygiene tutorial toy of claim 1 further comprising:
a base attached to said body;
a slot disposed in said base, said slot sized to accommodate a toothbrush; and
a recess disposed in said base, said recess sized to accommodate a drinking cup.

7. A method of instructing children in proper dental hygiene comprising the steps of:
providing a dental hygiene tutorial toy in a child friendly size and configuration;
installing a sound generation device within said dental hygiene tutorial toy;
recording a number of timed child appropriate instructions on proper dental hygiene on said sound generation device; and
providing a means for activating said sound generating device.

8. The method of instructing children in proper dental hygiene of claim 7 further comprising the step of:
electronically integrating a timer within said sound generation device; wherein said timer provides information on the proper length of time for brushing teeth, and notification of the actual time brushed.

9. The method of instructing children in proper dental hygiene of claim 7 further comprising the step of:
attaching a base to said dental hygiene tutorial toy;
disposing a slot in said base, said slot sized to accommodate a toothbrush;
forming a recess in said base, said recess sized to accommodate a drinking cup.
